(19) United States
(12) Patent Application Publication
(10) Pub. No.: US 2015/0134082 A1
(43) Pub. Date: May 14, 2015

(54) METHOD FOR OPERATING AN AUTOMATION SYSTEM

(71) Applicant: SIEMENS AKTIENGESELLSCHAFT, Muenchen (DE)

(72) Inventors: Thomas GROSCH, Rosstal (DE); Jürgen Laforsch, Buehl (DE); Albert Renschler, Ettlingen (DE)

(21) Appl. No.: 14/505,179

(22) Filed: Oct. 2, 2014

(30) Foreign Application Priority Data
Oct. 14, 2013 (EP) 13188435

(51) Int. Cl. G05B 19/05

(52) U.S. Cl. CPC G05B 19/052
USPC 700/3

(57) ABSTRACT

A method for operating an automation system provided with a first subsystem and a second subsystem which each process a control program in order to control a technical process, one of these subsystems operating as a master and the other subsystem operating as a slave, wherein measures are provided which make it possible to provide diagnostic and/or test data for diagnostic and/or test measures during control operation, in which case it is not necessary to dispense with a breakpoint function.

### BACKGROUND OF THE INVENTION

1. Field of the Invention

The invention relates to an automation system and a method for operating an automation system provided with a first subsystem and a second subsystem which each process a control program in order to control a technical process, where one of these subsystems operates as a master and the other subsystem operating as a slave.

2. Description of the Related Art

In the automation environment, there is an increasing demand for highly available solutions (H systems) that are suitable for minimizing possible downtimes of the installation. The development of such highly available solutions is very cost-intensive, an H system usually used in the automation environment being distinguished by the fact that two or more subsystems in the form of automation devices or computer systems are coupled to one another via a synchronization connection. In principle, both subsystems can have read and/or write access to the peripheral units connected to this H system. One of the two subsystems leads with respect to the peripherals connected to the system. This means that outputs to peripheral units or output information for these peripheral units is/are effected only by one of the two subsystems that operates as a master or has assumed the master function. So that both subsystems can run in a synchronous manner, the subsystems are synchronized at regular intervals via the synchronization connection. With respect to the frequency and extent of synchronization, different forms may be distinguished (e.g., warm standby, or hot standby).

An H system often requires a smooth “failover” if one of the subsystems fails and it is necessary to change over to the other subsystem. This means that, despite this unplanned changeover or this unplanned change from one subsystem to the other, this changeover or change does not have a disruptive effect on the technical process to be controlled. In this case, it is permissible for a (short) dead time, during which the outputs remain at their last valid process output values, to occur at the outputs of the connected peripherals. However, a jump (surge) in the values at these outputs on account of the changeover is undesirable and should therefore be avoided. Therefore, “smooth” should also be understood as meaning the continuity of the curve shape of the process output values.

In order to achieve this, the two subsystems must have the same system state at the time of the failure. This is ensured via of the suitable synchronization method. If both subsystems are processing the input information (inputs) of the process, both systems are in the same system state when they change their respective “thread global” data (shared data of programs, i.e., programs with different priorities) in the same manner given the same process input data or process input information. In order to achieve this, the synchronization method ensures that the individual threads of the two subsystems are interrupted or executed in the same manner. This results in an identical “thread mountain”.

The Siemens catalog ST 70, chapter 6, 2011 edition, discloses a redundant automation system (H system) that consists of two subsystems and is intended to increase the availability of an installation to be controlled. For this purpose, the automation system is provided with means that initially decide, based on an event, which program must be started to suitably react to the event. If, for example, during the execution of a program, an event in the form of a pending alarm for the technical process to be controlled is applied to a signaling input of the automation system, the running program is usually stopped at a waiting point and a program that is intended to analyze the alarm and initiate measures that eliminate the cause of the alarm is started. This automation system is regularly synchronized and it is ensured that the failure of one of these subsystems does not have a disruptive effect on a process to be controlled because the other subsystem can continue the execution or processing of the corresponding part of its respective control program or the execution or processing of the corresponding parts of this control program.

If, for example, an event that has occurred in a first subsystem is not synchronized with a second subsystem of an automation system comprising two subsystems and, after the event has been processed by the first subsystem, this subsystem fails, then the course of a technical process to be controlled may be disrupted. This is because the second subsystem without knowledge of the event runs through a different program path, representing the execution order of the programs, from the program path which would be run through by the second subsystem with knowledge of the event and which would also be necessary to avoid disrupting the course of the technical process to be controlled.

It is pointed out in this context that a program is understood as meaning both a program as such and a subroutine, a part of a program, a task, a thread, an organizational module, a functional module or another suitable program code for implementing an automation function, the programs of an automation system usually being categorized into priority classes and being processed or executed according to their associated priority.

Such a redundant automation or H system is usually used for years. During this long period of time, the situation may occur in which the installation is expanded with additional sensors and/or the respective control program of the subsystems, for example, and/or is optimized, the following test possibilities being provided for a user for the purpose of testing the changed control programs or changed program parts:

A) During start-up, the user can set one or more breakpoints in the respective control program. During this start-up, which is a non-critical phase from the point of view of the process, the automation or H system still operates in the solo mode and the so-called breakpoint function can be used. After reaching a breakpoint, the user can use an engineering system to view diagnostic data in succession, such as any desired variables of the respective subsystem (PLC). Which variable should be specifically tested next results, for example, from the values of the variables currently being examined. However, after start-up, i.e., during process control, such breakpoints must be dispensed with because otherwise a continuous mode can no longer be achieved in such a known automation system and would therefore contradict the “philosophy” of a redundant automation system. This is because such a continuous mode is an elementary operating mode for a redundant automation system and is therefore indispensable.

B) After start-up, i.e., within the scope of the redundantly running automation system for controlling the technical process (process control), only those functions that influence the processing of the control program only for a short time are available to the user. A preprepared list of variables is usually read out after the respective control program has been processed and is transmitted to the engineering system, and the processing of the respective control program within the scope of a further processing cycle is continued immediately afterward.

### SUMMARY OF THE INVENTION

It is therefore an object of the invention to provide an automation system and a method which makes it possible to provide diagnostic and/or test data for diagnostic and/or test measures during a control mode, in which case it is not necessary to dispense with a breakpoint function.

This and other objects and advantages are achieved in accordance with the invention by an automation system and method, where the automation system is provided with a first subsystem and a second subsystem that each process a control program to control a technical process, where one of the subsystems operates as a master and the other subsystem operates as a slave, and where the master is advantageously unburdened with the need to provide diagnostic and/or test data (diagnostic and/or test information)—referred to as diagnostic data below—and to transmit them to the engineering system. A user can predefine a plurality of diagnostic and/or test instructions in the slave control program, these instructions being irrelevant to the master. Only the slave processes these instructions and transmits all diagnostic data to the connected engineering system.

On account of the fact that the diagnostic data are processed using the slave, the temporal trailing, which represents the temporal difference (interval) between the beginning of the processing of the master processing sections and the beginning of the processing of the released slave processing sections, is increased. During the processing of the diagnostic data, the master releases accumulate in the slave but are initially disregarded. The slave continues its program processing using the accrued releases and processes the released processing sections of its slave control program only after the slave has transmitted all diagnostic data to the engineering system.

If the catch-up process has progressed to such an extent that the interval of time (trailing) between the master and the slave has reached the “normal” degree (a predefined value) again, the automation system again provides the full redundancy or changeover quality.

The user can allow himself any desired amount of time in the engineering system for interpreting the diagnostic data and can virtually “jump back and forth” between the individual data areas of the automation system (e.g., any desired variables of any desired data modules, or call hierarchy).

Diagnostic data are understood as meaning all data which are needed to diagnose and/or test the control program, the master control program or the slave control program corresponding to the master control program. Such data are, for example, system data, variables and their values, user data and/or process input data and process output data.

In order to be able to provide diagnostic data for suitable diagnostic and/or test measures during process control (during the control mode), both the master and the slave run through the program paths in a temporally asynchronous manner. This means that the master temporally leads the slave or the slave trails the master with regard to the program processing. As explained, “trailing” or “leading” is understood as meaning the temporal difference between the beginning of the processing of the processing sections by the master and the beginning of the processing of the processing sections by the slave, which corresponds to the time at which the respective release occurs.

In one embodiment of the invention, the automation system is provided with a master CPU and a slave CPU, where the slave assumes the function of the master if the master fails. A redundant automation system is implemented thereby, where the slave provides the engineering system with the diagnostic data during the control mode or during process control over and above the redundancy functionality.

In another embodiment of the invention, the master and the slave are parts of a multicore CPU, a first core of the multicore CPU being in the form of a master and a second core of the multicore CPU being in the form of a slave. In this case, the slave is provided only for the purpose of providing the diagnostic data, the multicore CPU operating in a solo mode or in a non-redundant mode. It should be understood that two such multicore CPUs may be parts of a redundant automation system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, its refinements and advantages are explained in more detail below using the drawing which illustrates an exemplary embodiment of the invention, in which:

FIGS. 1 and 2 show sequences of temporally asynchronous coupling of two subsystems;

FIG. 3 shows a redundant automation system; and

FIG. 4 is a flowchart of the method in accordance with the invention.

### DETAILED DESCRIPTION OF THE PREFERRED EMBODIMENTS

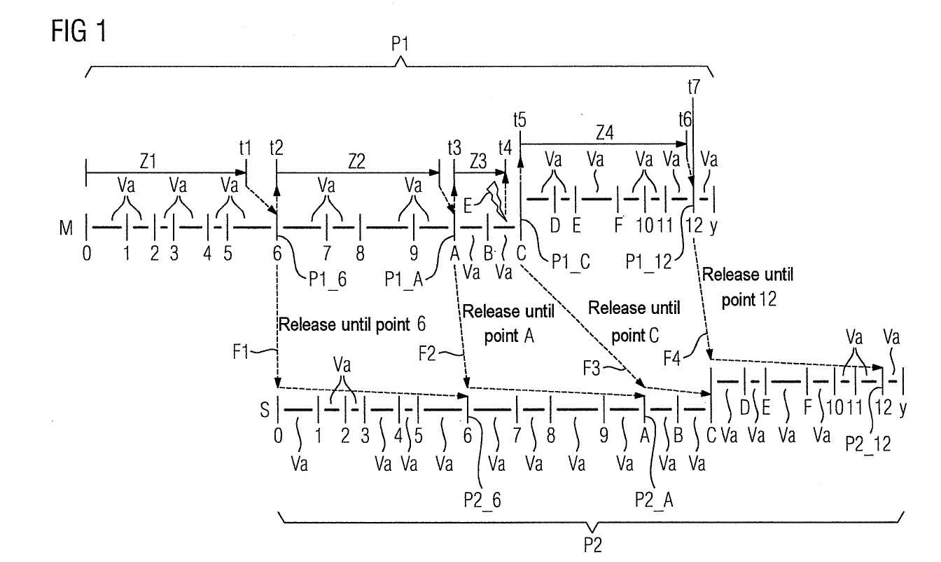

The same parts in FIGS. 1 to 3 are provided with the same reference symbols.

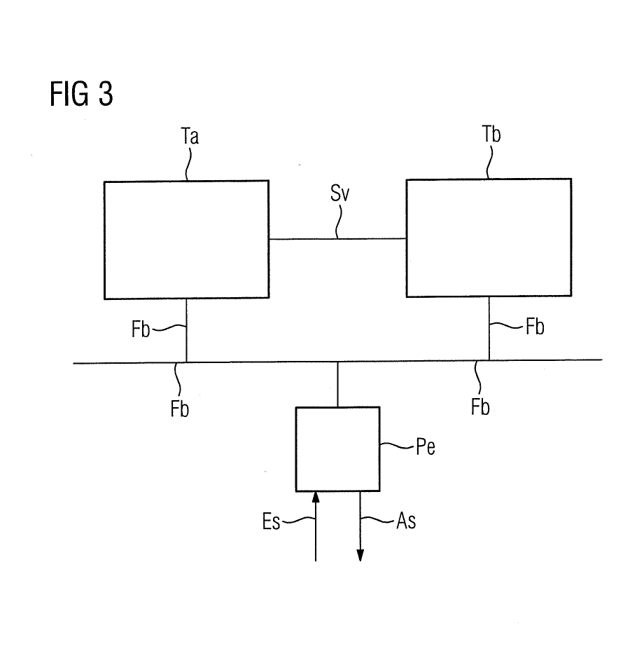

Reference is first of all made to FIG. 3, which illustrates a redundant automation system, which is known per se, and, which comprises two subsystems. A first subsystem Ta and a second subsystem Tb are connected to a peripheral unit Pe via a field bus Fb. In this case, the field bus Fb complies with the PROFIBUS-DP specification, for example. In principle, other bus systems, such as Ethernet, Fieldbus, Modbus, or parallel bus systems, are also suitable. The peripheral unit Pe receives, via input lines Es, signals from transducers or measuring transducers, which are used to detect a process state, and outputs, via output lines As, signals to actuators that are used to influence the process. The process as well as the transducers, measuring transducers and actuators are not illustrated in the figure for the sake of clarity. The two subsystems Ta, Tb execute the same control program in a cyclical and synchronous manner. A synchronization connection Sv is provided in order to synchronize the subsystems, where the redundancy and monitoring functions are implemented via this synchronization connection Sv.

In order to be able to provide diagnostic and/or test data for diagnostic and/or test measures during process control (during the control mode) in a redundant automation system having two subsystems, provision is made for both subsystems to run through the control programs or program paths in a temporally asynchronous manner.

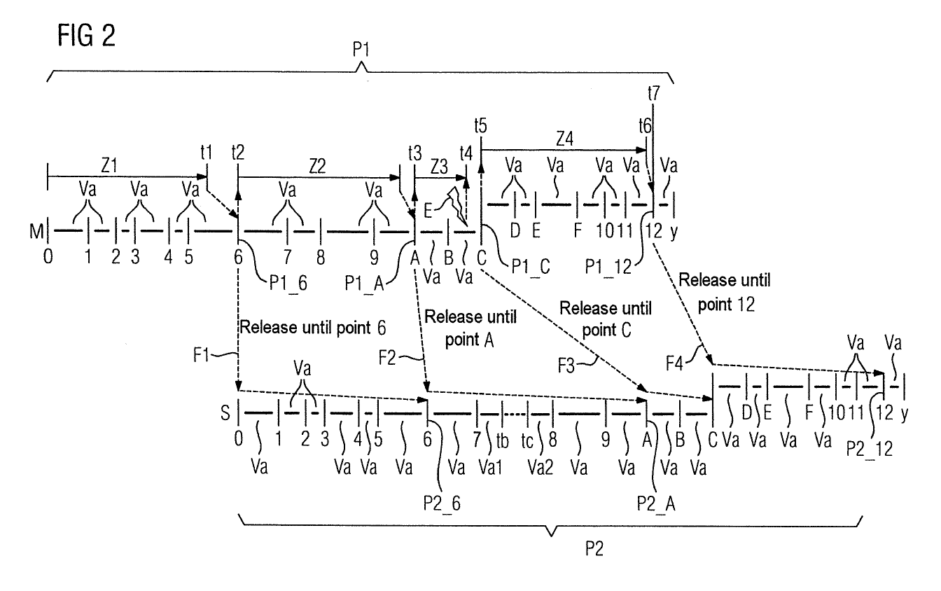

For a more detailed explanation, reference is made below to FIGS. 1 and 2 which illustrate sequences of temporally asynchronous coupling of two subsystems. The two subsystems perform “event-synchronous processing”, which means that both subsystems run through the same program paths of the respective control program on account of an event, in which case the runs occur in a temporally asynchronous manner.

It is assumed that one subsystem is operated as a master M and one subsystem is operated as a slave S or a reserve. The master M therefore leads with respect to the control of a technical process and undertakes process control, the master reading the process input information or process input values from the peripheral unit Pe (FIG. 3) and making it/them available to the slave S in a temporally asynchronous manner. The slave S assumes the master function or the role of master only if the master M fails on account of a fault.

The master M processes a program P1 for controlling the technical process, the slave S also processing a program P2 corresponding to this control program P1. Both control programs P1, P2 have a multiplicity of processing sections (Va) of different duration, the control programs P1, P2 being able to be interrupted at the respective beginning and the respective end of each processing section Va. The beginning and end of each processing section Va, which usually comprises a multiplicity of program codes, therefore represent interruptible program points or breakpoints 0, 1, 2, . . . y. If necessary, the respective control program P1, P2 can be interrupted at these points 0, 1, 2, . . . y using the master M and the slave S in order to be able to initiate suitable reactions after an event or a process alarm has occurred. Furthermore, the respective control program P1, P2 can be interrupted at these breakpoints 0, 1, 2, . . . y so that the master M and the slave S can interchange releases, acknowledgements or other information via the field bus Fb or via the synchronization connection Sv (FIG. 3). After a respective predefinable or predefined interval of time Zi, 1=1, 2, . . . has expired and at the respective time at which a breakpoint following the expiry of the respective interval of time Zi occurs, preferably the first breakpoint following the respective interval of time Zi, the master M transmits a release or release signal to the slave S, which release or release signal indicates to the slave S the processing section Va up to which the slave S can process the control program P2. These processing sections Va of the control program P2 correspond, in terms of process control, to those which have already been processed by the master M during the processing of the control program P1. In the present exemplary embodiment, it is assumed that, after an interval of time Z1 has expired, the master M transmits a release F1 to the slave S at a time t1 and at a time t2 at which a first breakpoint P1_6 (breakpoint 6) follows the interval of time Z1. This release F1 comprises the information for the slave S indicating that the latter can process its control program P2 to be processed up to a breakpoint P2_6 (breakpoint 6), the breakpoint P2_6 of the control program P2 corresponding to the breakpoint P1_6 of the control program P1. This means that, based on the release, the slave S can process those processing sections Va of the control program P2 that correspond to the processing sections Va of the control program P1 up to the time at which the release or the release signal is generated, in which case it is assumed in the example for the sake of simplicity that the time at which the release is generated corresponds to the time at which the release is transmitted to the slave S. These processing sections Va are therefore processed using the slave S in a temporally asynchronous manner with respect to the processing of the corresponding processing sections Va using the master M, the slave S processing further processing sections Va, after the processing sections Va of the control program P2 have been processed by the slave S, only when the master M transmits a further release to the slave S.

The time at which this breakpoint P1_6, P2_6 (breakpoint 6) occurs represents the beginning of an interval of time Z2 following the interval of time Z1.

The further temporally asynchronous processing of the control programs P1, P2 is performed in the described manner. At a time t3 at which a first breakpoint P1_A occurs after the expiry of the interval of time Z2, the master M transmits a further release F2 to the slave S, which release F2 indicates to the slave S that the latter can process further processing sections Va up to the breakpoint P2_A. These processing sections Va again correspond to those which have already been processed by the master M from the time t2 to the time t3, i.e., up to the breakpoint P1_A. This means that the slave S processes the processing sections Va from the time t2 of the previous release F1 to the time t3 of the current release F2. The time t3 at which the first breakpoint P1_A has occurred after the expiry of the interval of time Z2 is the beginning of an interval of time Z3 following the interval of time Z2.

An event, such as an event in the form of a process alarm, may now occur during an interval of time. In the exemplary embodiment, E is used to denote such an event to which the master M must react in a suitable manner during the interval of time Z3 at a time t4 in accordance with the control program P1. In this case, the master M does not transmit a release F3 to the slave S at a time at which a breakpoint following the interval of time Z3 occurs after the interval of time Z3 but rather at a time t5 at which a breakpoint P1_C (breakpoint C) following the occurrence of the event E occurs. This means that the interval of time Z3 is shortened on account of the event E, the time t5 being the beginning of a following interval of time Z4. Based on the release F3 transmitted to the slave S, the slave S processes those processing sections Va of the control program P2 that correspond to those processing sections Va of the control program P1 that have already been processed by the master M between the times t3 and t5.

On account of the event E, the master M processes higher-priority processing sections Va during the interval of time Z4, for example, the master M performs a thread change at the time t5, and, after the interval of time Z4 has expired at the time t6, again transmits a release F4 at a time t7 at which a first breakpoint P1_12 (breakpoint 12) following the interval of time Z4 occurs. Based on this release, the slave S likewise processes processing sections Va up to a breakpoint P2_12 (breakpoint 12) in the control program P2, these processing sections Va corresponding to the processing sections Va of the control program P1 between the times t5 and t7, and the slave S likewise perform a thread change.

As explained, the releases from the master M make it possible for the slave S to run through the same “thread mountain” as the master M, which means that the slave S performs a “thread change” at a point in the control program P2 corresponding to the point of the thread change in the master control program P1. The slave S continues its processing only when requested to do so by the master M via a release. With regard to the processing of the processing sections, the master M processes them in real time like in a stand-alone mode or in a non-redundant mode and issues releases for corresponding processing sections to be processed by the slave S at regular intervals of time and after the occurrence of events, the master M continuing to process its control program P1 and not actively waiting for a response from the slave S. With regard to the processing of the corresponding processing sections, the slave S trails the master M and processes the sections based on the issued master releases.

In order to be able to provide an engineering system connected to the automation system with diagnostic and/or test data during control of the technical process (during the control mode), the slave control program P2 has diagnostic and/or test instructions, in which case the term “instruction” is also understood as meaning a “command”. In the present exemplary embodiment, the slave control program P2 (FIG. 2) is provided with a diagnostic and/or test instruction (referred to as an instruction below) at a time tb within a processing section Va, the slave S providing the engineering system with diagnostic data from this time tb to a time tc based on this instruction in the slave control program P2 and transmitting the data to the engineering system, which is illustrated using a dashed line in the drawing. The time tb represents a “breakpoint” from which the slave S interrupts the processing of the processing section Va of the slave control program P2, which means that the slave S processes only a part Val of the processing section Va.

After these diagnostic data have been transmitted, the slave S continues the processing of the processing section Va of the slave control program P2 from the time tc and processes a further part Va2 of the processing section Va. On account of the fact that the slave S has transmitted the diagnostic data from the time tb to the time tc, the trailing is increased. The interval of time between the advancing master control program processing and the slave control program processing, which is at a “standstill” with respect to the process control, is increased. In order to reduce this trailing, the slave S processes the processing sections Va of the slave control program P2 more quickly relative to the processing of the processing sections Va of the master control program P1, at least from the time tc to the time at which the following release signal F3 is received. If the “race to catch up” has progressed to such an extent that the interval of time or the trailing has reached a predefined or predefinable value, the “full” redundancy or changeover quality is achieved again.

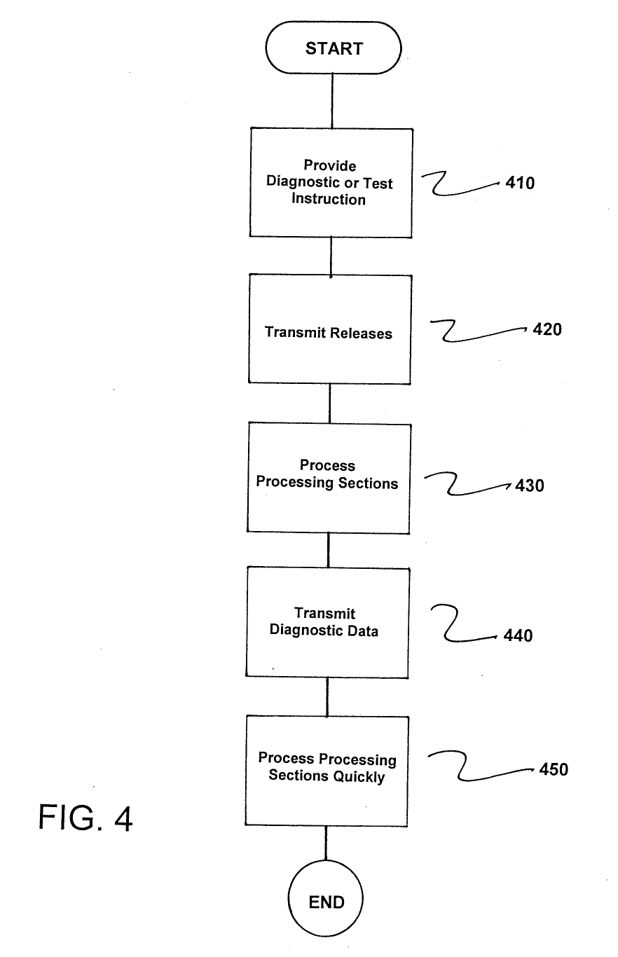

FIG. 4 is a flow chart of a method for operating an automation system provided with a first subsystem and a second subsystem which each process a control program (P1, P2) to control a technical process, where one of the first and second subsystems operates as a master (M) and the other of the first and second subsystems operates as a slave (S).

The method comprises providing a slave control program (P2) with at least one of (i) at least one diagnostic instruction and (ii) at least one test instruction, as indicated in step 410.

Next, the master (M) is utilized to transmit releases (F1, F2, F3, F4) to the slave (S), as indicated in step 420. Here, the releases (F1, F2, F3, F4) indicates to the slave (S) which processing sections (Va) of the slave control program (P2) can be processed by the slave (S), where these processing sections (Va) correspond to the processing sections (Va) of the master control program (P1) which have already been processed;

The slave (S) is then utilized to process processing sections (Va) of the slave control program (P2), which have been released based on the releases (F1, F2, F3, F4), with temporal trailing, as indicated in step 430.

Next, the slave (S) is utilized to transmit diagnostic data to an engineering system if either the at least one diagnostic instruction or the at least one test instruction is processed in the slave control program (P2), as indicated in step 440.

The processing sections (Va) of the slave control program (P2) are now processed more quickly relative to the processing of the processing sections (Va) of the master control program (P1) to reduce the temporal trailing of the processing to a predefined value, as indicated in step 450.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an automation system provided with a first subsystem and a second subsystem which each process a control program to control a technical process, one of said first and second subsystems operating as a master and another of said first and second subsystems operating as a slave, the method comprising:
providing a slave control program with at least one of (i) at least one diagnostic instruction and (ii) at least one test instruction;
utilizing the master to transmit releases to the slave, the releases indicating to the slave which processing sections of the slave control program can be processed by the slave, these processing sections corresponding to the processing sections of the master control program which have already been processed;
utilizing the slave to process processing sections of the slave control program, which have been released based on the releases, with temporal trailing;
utilizing the slave to transmit diagnostic data to an engineering system if one of (i) the at least one diagnostic instruction and (ii) the at least one test instruction is processed in the slave control program; and
processing the processing sections of the slave control program more quickly relative to the processing of the processing sections of the master control program to reduce the temporal trailing of the processing to a predefined value.

2. The method as claimed in claim 1, wherein the automation system is implemented as a redundant automation system having a master CPU and a slave CPU, the slave assuming functionality of the master if the master fails.

3. The method as claimed in claim 1, wherein the master is implemented in one core of a multicore CPU and the slave is implemented in a further core of the multicore CPU.

4. An automation system provided with a first subsystem and a second subsystem which each process a control program to control a technical process, one of the first and second subsystems operating as a master and another of the first and second subsystems operating as a slave;
wherein the slave control program is provided with at least one of (i) at least one diagnostic instruction and (ii) at least one test instruction;
wherein the master is configured to transmit releases to the slave, the releases indicating to the slave which processing sections of the slave control program can be processed by the slave, these processing sections corresponding to the processing sections of the master control program which have already been processed;
wherein the slave is configured to process processing sections of the slave control program, which have been released based on the releases, with temporal trailing, the slave being further configured to transmit diagnostic data to an engineering system if one of (i) the at least one diagnostic instruction and (ii) the at least one test instruction is processed in the slave control program, and configured to process the processing sections of the slave control program more quickly relative to the processing of the processing sections of the master control program to reduce the temporal trailing of the processing to a predefined value.

5. The automation system as claimed in claim 4, wherein the automation system is a redundant automation system having a master CPU and a slave CPU, the slave assuming functionality of the master if the master fails.

6. The automation system as claimed in claim 4, wherein the master and the slave form parts of a multicore CPU, a first core of the multicore CPU comprising the master and a second core of the multicore CPU comprising the slave.

7. A slave for the automation system as claimed in claims 4 to 6 which is provided with the first subsystem and the second subsystem which each process the control program to control the technical process, one of the first and second subsystems operating as the master and another of the first and second subsystems operating as the slave;
wherein the slave control program is provided with at least one of (i) at least one diagnostic instruction and (ii) at least one test instruction;
wherein the slave is configured to process processing sections of the slave control program, which have been released based on master releases which have been transmitted to the slave and indicate to the slave which processing sections of the slave control program can be processed by the slave, with temporal trailing, the slave being further configured to transmit diagnostic data to the engineering system if the one of (i) the at least one diagnostic instruction and (ii) the at least one test instruction is processed in the slave control program, and configured to process the processing sections of the slave control program more quickly relative to the processing of the processing sections of the master control program to reduce the temporal trailing of the processing to the predefined value.
